(19) United States
(12) Patent Application Publication
(10) Pub. No.: US 2008/0129751 A1
(43) Pub. Date: Jun. 5, 2008

(54) Smart Blanking Graphics Controller, Device Having Same, And Method

(76) Inventor: George Lyons, Langley (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/566,551

(22) Filed: Dec. 4, 2006

(51) Int. Cl. G09G 5/00

(52) U.S. Cl. 345/619

(57) ABSTRACT

A graphics controller for preventing display artifacts from occurring in an output display image is described. The graphics controller includes input window logic, output window logic, line counter logic, smart blanker logic, and a display interface. The smart blanker logic is configured to receive image data from the output window logic and generate modified image data. The modified image data contains output image data in a region of the output display image that will not contain the display artifacts and data for blank pixels in a region of the output display image that can contain the display artifacts. The display interface is configured to receive the modified image data and output the modified image data to a display device.

### BACKGROUND

Electronic devices with display screens generally employ a microprocessor that runs software for generating display content. Depending on the device, the software may provide, by way of the display screen, various information to the user of the device. For example, a cell phone may display information relating to a current telephone call, a portable music player may display information relating to a current song being played, a digital camera may display a current image for review, and a personal data assistant may generate a display relating to an appointment or contact list. In each case, the display data is passed along with control codes to a graphics controller device which receives the display data. The graphics controller implements any commands received in the control codes and drives a connected display device. The display device is typically a liquid crystal type display, although other display devices are known or may be suitable to the intended purpose of the device.

As such electronic devices have become more sophisticated, the graphics controller is relied on increasingly for implementing new features such as windowing, image resizing, and image decompression. In windowing, the graphics controller receives display data for display on a portion of the display screen, referred to as a window, which may be equal to or less than the entire size of the display. For example, if a display screen is capable of displaying 640 by 480 pixels, it can, by use of certain control codes, be directed to display a 100×100 pixel window with the upper left hand corner of the window being located 50 pixels from the top and 50 pixels from the left side of the screen. Then, new data received by the graphics controller is used to paint only that portion of the display.

In display resizing, the graphics controller can be directed to resize an input image to a new output size, for display either within a window or to cover the entire display screen. Thus, a small input image of 50×50 pixels can be remapped by the graphics controller to cover the entire 640 by 480 pixel display area. Likewise, a larger image can be remapped by the graphics controller to be displayed on a smaller window of the display. It is also possible for a large image to be reduced in size and mapped to the entire display area.

In image decompression, the graphics controller may receive image data in a compressed format. Rather than decompressing the image data using the microprocessor, which can take many processor cycles to complete, the graphics controller may be hard-wired with logic circuits for decompressing the image data. The decompression logic may be turned on and off in accordance with instructions received by way of control codes from the processor. This allows more image data to be stored in a smaller memory space, and reduces processor load and concomitant battery consumption by off-loading image decompression tasks to the graphics controller.

One disadvantage of providing the capability to resize image data and of providing decompression and windowing functionality, is the danger of generating temporary display artifacts in an architecture having a single frame buffer. This can occur, for example, when the graphics controller is instructed to resize an image or provide a window where the data for displaying the resized data has not yet been received. Typically, the graphics controller implements the new resizing and/or windowing functionality immediately upon receiving the instructions to do so, without waiting for new data to fill the new display space. For example, suppose the graphics controller is currently displaying the image of a pie-chart, which fills the entire region of the display when the software operating in the processor reprograms the display to resize a new image which is one-quarter the size of the screen, but is to be resized to fit the entire display screen. The processor will send the instruction to the graphics controller to resize the display, and then send the image data relating to the quarter-size image. Instantly upon receiving the instruction to resize the display, the pie-chart currently being displayed will be corrupted in some way. For example, it might be zoomed so that the user briefly sees only ¼ of the pie chart while the new image data is written to the graphics controller. As can be appreciated, sending new image data prior to the control codes would be equally as undesirable since the new data will corrupt the previous image until the control code is received.

One way of avoiding display artifacts is to provide a double frame buffer such that new data is written to its own non-display buffer until the writing is completed, and then the display buffers are switched. However, the additional memory associated with double frame buffers can take valuable die real-estate, particularly in today's higher resolution, high bit-depth displays. Therefore, this may not be a viable solution for low-cost devices.

Another mechanism for preventing undesirable display artifacts is to write data to the graphics controller during non-display periods of the display. As is generally known, most display devices have a definable refresh rate, e.g., 60 frames per second. The graphics controller passes data to the display device for each frame refresh. After all the data is written to the display, however, there may be a period during which no data is written to the display. If the host CPU can write new data to the frame buffer of the graphics controller during this non-display period, then no display artifacts will appear. Unfortunately, with higher resolution displays, it is sometimes not possible to write the required amount of image data within a single non-display period in order to prevent display artifacts. Furthermore, in some devices, the host CPU may not have a reliable mechanism for synchronizing image data writes to the non-display period. For instance, the host CPU may poll an internal register of the graphics controller for an indication as to whether the graphics controller is in a non-display period, or the graphics controller can provide an interrupt signal to the host CPU. Both mechanisms have limitations: Polling a graphics controller register can take valuable CPU bandwidth in order to accurately identify the beginning of the non-display period, and an interrupt signal does not guarantee that the CPU will be immediately available to write the image data, particularly if it is busy with another process.

Accordingly, a mechanism is desired for overcoming the above limitations, and for preventing display artifacts from occurring when a new display mode is engaged.

### SUMMARY

Broadly speaking, the present invention fills these needs by providing a smart blanking graphics controller, device having same, and a method. It should be appreciated that the present invention can be implemented in numerous ways, including as a process, an apparatus, a system, a device, or a method. Several inventive embodiments of the present invention are described below.

In one embodiment, a graphics controller for preventing display artifacts from occurring in an output display image is provided. The graphics controller includes input window logic, a memory, output window logic, line counter logic, smart blanker logic, and a display interface. The input window logic is configured to receive input image data from a host central processing unit (CPU). Input image data comprises a plurality of intensity values for a plurality of pixels of an input image. The input window logic is further configured to write the input image data to the memory in accordance with control codes received from the host CPU and identify whether the control codes include predetermined control codes that can result in display artifacts. The output window logic is configured to read output image data from the memory. The line counter logic is configured to count lines of input image data received from the host CPU since receipt of the predetermined control codes. Each line of input image data corresponds to a row of pixels of the input image. The smart blanker logic is in electronic communication with the output window logic and the line counter logic. The smart blanker logic is configured to receive image data from the output window logic and generating modified image data. The modified image data contains the output image data in a region of the output display image that will not contain the display artifacts and data for blank pixels in a region of the output display image that can contain the display artifacts. The display interface is configured to receive the modified image data and output the modified image data to a display device.

In another embodiment, an electronic device having a smart blanking feature to prevent display artifacts is provided. The electronic device includes a host central processing unit (CPU), a display device, and a graphics controller. The display device has a display screen and is configured to display an output image on the display screen. The graphics controller includes input window logic, a memory, output window logic, line counter logic, smart blanker logic, and a display interface. The input window logic is in electronic communication with the host CPU and is configured to receive input image data from the host CPU. The input image data includes a plurality of color or intensity values for a plurality of pixels of an input image. The input window logic is further configured to write the input image data to the memory in accordance with control codes received from the host CPU and identify whether the control codes include predetermined control codes that can result in display artifacts. The output window logic is configured to read output image data from the memory. The line counter logic is configured to count lines of input image data received from the host CPU since receipt of the predetermined control codes. Each line of input image data corresponds to a row of pixels of the input image. The smart blanker logic is in electronic communication with the output window logic and the line counter logic. The smart blanker logic is configured to receive image data from the output window logic and generate modified image data. The modified image data contains the output image data in a region of the output display image that will not contain the display artifacts and data for blank pixels in a region of the display that can contain the display artifacts. The display interface is in communication with the display device, the display interface being configured for receiving the modified image data and outputting the modified image data to the display device.

In yet another embodiment, a method for preventing display artifacts from occurring in an output display image is provided. In the method, input image data is received from a host central processing unit (CPU). The input image data comprises a plurality of intensity values for a plurality of pixels of an input image. The input image data is written to a memory in accordance with control codes received from the host CPU. It is determined whether the control codes received from the host CPU can result in display artifacts. The output image data is read from the memory. When it is determined that the control codes received from the host CPU can result in display artifacts, the lines of input image data received from the host CPU since receipt of the control codes are counted and the image data received from the output window logic is modified using a smart blanker. Each line of input image data corresponds to a row of pixels of the input image. The smart blanker generates modified image data, the modified image data containing the output image data in a region of the output display image that will not contain the display artifacts and data for blank pixels in a region of the output display image that can contain the display artifacts.

The advantages of the present invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 shows an electronic device having a smart blanking feature to prevent display artifacts.

FIG. 2 shows detail of a graphics controller of the electronic device of FIG. 1.

FIG. 3 shows a flow chart of an exemplary method carried out by the graphics controller of FIG. 2.

### DETAILED DESCRIPTION

In the following description, numerous specific details are set forth in order to provide a thorough understanding of the present invention. However, it will be apparent to one skilled in the art that the present invention may be practiced without some of these specific details. In other instances, well known process operations and implementation details have not been described in detail in order to avoid unnecessarily obscuring the invention.

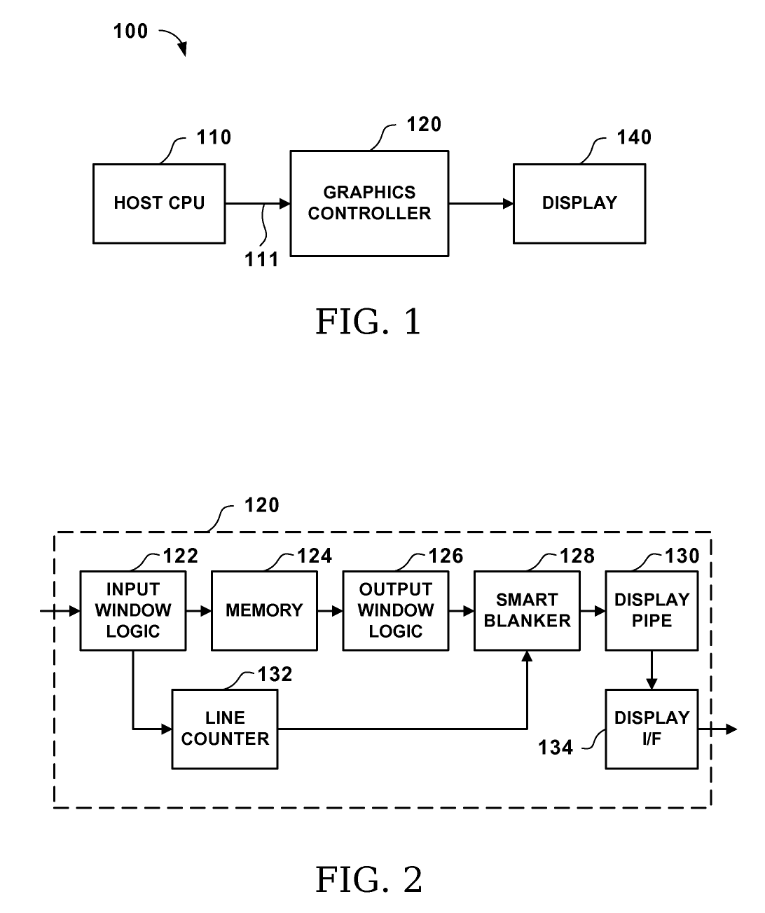

FIG. 1 shows a high-level block diagram of an exemplary electronic device 100. Device 100 includes a Host central processing unit (CPU) 110, a graphics controller 120, and a display device 140. Those skilled in the art will recognize that device 100 may include many other components not represented in FIG. 1, depending on the intended use of the device. Host CPU executes program instructions, which may be obtained from a main memory (not shown), and generates display data that is conveyed to graphics controller 120 via data lines 111. Data lines 111 may include multiple data and address lines, although it is represented in FIG. 1 as a single line for purposes of this description.

The display data transmitted to graphics controller 120 may include image data and control codes. The control codes direct the graphics controller to perform specific functions in handling the image data. For example, control codes may be used to implement windowing, image resizing, and image compression so as to off-load these operations from Host CPU. The image data sent to graphics controller 120 therefore can represent any size image, which, using the control codes, can be used to paint any size window of the output image up to and including the size of the output image. Therefore, if the input image is smaller than the output image, then the input image can be painted over a designated portion of the output image using windowing, or over the entire output image using resizing. In addition, the input image may be reduced or enlarged, and mapped to any portion of the output image as desired, simply by providing the appropriate control codes to graphics controller 120. Furthermore, the image sent to graphics controller 120 may be compressed. Image data that is compressed requires fewer data bits to represent the image than uncompressed image data. Compressed image data takes less memory, fewer processor cycles to handle, and less time to transmit to graphics controller 120. However, the host CPU must instruct the graphics controller when to decompress the image data by sending control codes. When implementing control codes, graphics controller effectively switches display modes. To prevent display artifacts from occurring during a change in display mode, graphics controller 120 implements a smart blanker is described in detail below with reference to FIG. 2.

Display device 140 may be implemented by any suitable display device for translating image data into a viewable image. For example, display device 140 may be a liquid crystal display (LCD) panel. Other technologies may also be available for representing viewable display data. Examples of such alternative display devices include electronic paper, plasma screen, organic light emitting diodes, and cathode ray tube devices. In one embodiment, display device 140 refreshes periodically by reading new image data from graphics controller 120 thereby updating the output image according to new data written to graphics controller 120 by Host CPU.

FIG. 2 shows a block diagram showing by way of example certain components of graphics controller 120. Those skilled in the art will recognize that graphics controller may contain numerous additional logic blocks to implement additional features, depending on the intended use of the graphics controller. Thus, FIG. 2 shows a simplified view of graphics controller 120 for the purpose of illustrating smart blanking functionality without cluttering up the figure with unnecessary details.

Input window logic 122 comprises logic circuitry for receiving display data from Host CPU 110 (FIG. 1). Display data may include input image data and control codes. Input image data is an internal representation of an input image. Input window logic writes the input image data to memory 124 in accordance with control codes received from host CPU 110. Such control codes can be used to designate a specific area of memory 124 to write new image data, thereby preventing overwriting of some previous image data thereby allowing compositing of the old and new images. Because of the windowing and resizing functionality of graphics controller 120, the input image may be different from the image ultimately presented on display 140 (FIG. 1). For example, the input image may simply update a clock disposed in one corner of final image presented by display 140. Using the windowing feature, the clock can be updated without repainting the entire image. The final image therefore may be a composite of the previous image and the new input image.

When certain predetermined control codes are received and recognized by input window logic 122, input window logic 122 sends a signal to line counter 132. The predetermined control codes, such as changes in resizing, windowing, and data compression enablement, that can result in display artifacts. The signal may identify a total number of lines in the input image window to be filled by incoming input image data. Each line of image data represents one row of pixels of the image that the image data represents. The row may extend vertically or horizontally across the input image. Each time a new line of image data is received, input window logic 122 sends a signal to line counter 132. Line counter 132 may be configured to count from zero to the total number of lines in the input window, or to count down from the total number of lines of the input window to zero. In either case, line counter 132 keeps track of the number of new input image data lines written to the current input window since the predetermined control codes were received and recognized by the input window logic.

Memory 124 may be a frame buffer or other memory accessible to both input window logic 122, which writes input image data to memory 124, and output window logic 126, which reads output image data from memory 124. Memory 124 therefore holds image data written by input window logic 122 until overwritten with new input image data.

Output window logic 126 reads output image data from memory 124 in accordance with control codes received from host CPU 110 (FIG. 1). In one embodiment, for instance, less than a full-sized image's worth of output image data may be read from memory 124 by output window logic 126 when host CPU enables image resizing or image decompression functions of graphics controller 120. For example, if image resizing is enabled such that the input image is magnified 4 times to generate the final image data for display on display device 140 (FIG. 1), then output window logic 126 will read only ¼ of the data required to represent a full-size, full-resolution image.

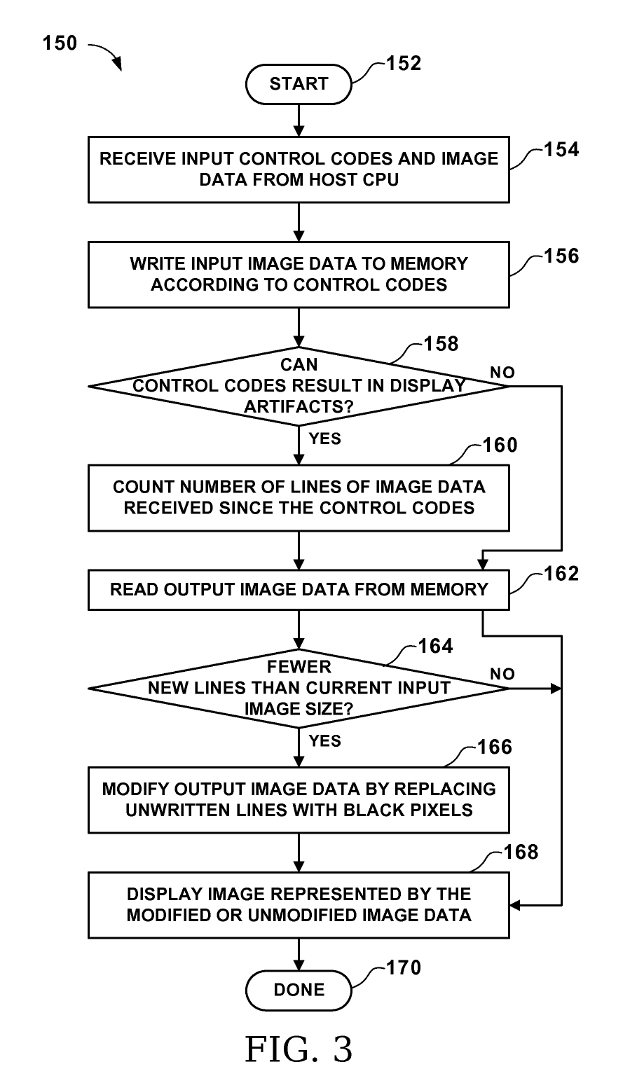

Smart blanker logic 128 receives output image data read from memory 124 by output window logic 126, and modifies it to prevent display artifacts as described below with reference to FIG. 3. As mentioned previously, line counter 132 keeps track of the number of new input image data lines written to the current input window since the predetermined control codes were received and recognized by the input window logic. Smart blanker 128 reads the line number count from line counter logic 132 and modifies the output image data by blanking lines corresponding to unwritten lines in the input window, as determined from the line number received from line counter 132. The blank lines are formed by replacing the data line with data representing blank pixels. In one embodiment, the blank pixels are simply black pixels. However, it is also possible to replace the pixels represented by the output image data with any color pixel. Alternatively, the color of blanking can be selected by reading a color or intensity value from a register (not shown) or other memory location accessible by host CPU 110 (FIG. 1). In this example, the host CPU would write the color for smart blanking to the register, and that value would be used when modifying pixels represented by the output image data. Regardless of the color of the modified pixels, the modified image data is then passed to display pipe 130.

Display pipe 130 receives the modified image data. Display pipe 130 may also help to implement control codes received from host CPU by directing output window logic 126 which memory to read and when. For example, display pipe 130 can be used to implement image resizing and/or image decompression. The display pipe 130 passes the modified image data to display interface 134, which drives the display device 140 (FIG. 1). Those skilled in the art will recognize that different display types and different implementations of display devices of the same display type require different interfaces for properly driving the display device. The required interface is both physical in that the electrical connections between display interface 134 and display device 140 must correspond for proper communication, and also logical, in the sense that data and various control codes must be provided to display device 140 in accordance with the display device manufacturer's requirements. FIG. 3 shows a flowchart 150 illustrating an exemplary procedure carried out by graphics controller 120 of FIG. 2. It should be noted that, because of the nature of flow charts, the procedure is shown as being a sequential series of steps, when in actuality, many of the steps may be carried concurrently in different parts of graphics controller 120. For example, data may be received and written to memory 124 contemporaneously as data is read from memory 124 and passed to display interface 134. Therefore, although the flowchart 150 may suggest that each step is completed prior to beginning the following step, in an actual device, all or most the steps may be carried out concurrently.

The procedure begins as indicated by start block 152 and proceeds to operation 154, wherein input control codes and image data are received from the host CPU. In operation 156, the image data is written to memory according to the control codes. The control codes may determine where in memory the input image data is written. For example, the control codes may define an input window, which is a designated portion of the memory that corresponds to a region of the final output image that is displayed by display device 140 (FIG. 1).

In operation 158, it is determined whether the control codes are ones which can result in display artifacts. If the control codes are not ones that can result in display artifacts, then the procedure jumps to operation 162 and then to operation 168 for reading output image data from the memory and then displaying the image represented by the output image data. Otherwise, the procedure flows from operation 158 to operation 160.

In operation 160, the number of lines of input image data received since receipt of the control codes that can result in display artifacts was received, is counted. In operation 162, output image data is read from the memory. In operation 164, it is determined whether the counted number of lines of input image data is less than the number of lines of the input window. If the number of lines counted is equal to (or greater than) the number of lines of the input window, then the procedure ends as indicated in operation 168. Otherwise, the procedure flows to operation 166 wherein the output image data read from the memory is modified by replacing pixels corresponding to a region of the image represented by the output image data that can contain display artifacts with blank pixels. In one embodiment, only output image data lines corresponding to input image data lines not yet written to are modified. As mentioned previously, the blank pixels may be black pixels, pixels of another selected color, or pixels having a color according to a color value read from a register that is accessible by host CPU 110.

After the modified data is generated, the modified data is sent to a display device for displaying the final image formed by the modified data (or unmodified data, if there were no control codes that could result in display artifacts in operation 158) to the user. The procedure then ends as indicated by done block 170. Flowchart 150 is for illustration purposes only. It should be noted that this procedure is repeated continually, and that the write operation associated with operations 154-160 are loosely coupled to the read operation associated with operations 162-168 such that read operation can be carried out continually whether or not any write operations are occurring. However, when a write operation is occurring, and it is accompanied by control codes described with respect to operation 158, the read operation is affected as described above by causing the output image data to be modified by the smart blanker.

It should also be recognized that the procedure described above with reference to FIG. 3 is performed in hardware using logic gates, and therefore not necessarily sequentially as might be suggested by the flowcharts. Thus, many operations may be performed in parallel and/or in a different order than presented above. Furthermore, there may be instances where a particular operation is combined with other operations such that no intermediary state is provided. Likewise, various operations may be split into multiple steps with one or more intermediary states. Graphics controller 120 (FIG. 1) and other hardware devices incorporate logic typically designed using a hardware description language (HDL) or other means known to those skilled in the art of integrated circuit design. The generated circuits may include numerous logic gates and connectors to perform various operations and does not necessarily rely on software instructions. It is also possible to implement the procedures described above in software for execution on a processing device.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated. Further, the manipulations performed are often referred to in terms such as producing, identifying, determining, or comparing.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

Embodiments of the present invention can be processed on a single computer, or using multiple computers or computer components which are interconnected. A computer, as used herein, shall include a standalone computer system having its own processor(s), its own memory, and its own storage, or a distributed computing system, which provides computer resources to a networked terminal. In some distributed computing systems, users of a computer system may actually be accessing component parts that are shared among a number of users. The users can therefore access a virtual computer over a network, which will appear to the user as a single computer customized and dedicated for a single user.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A graphics controller for preventing display artifacts from occurring in an output display image, the graphics controller comprising:
input window logic for receiving input image data from a host central processing unit (CPU), the input image data comprising a plurality of intensity values for a plurality of pixels of an input image, the input window logic being configured to write the input image data to a memory in accordance with control codes received from the host CPU, the input window logic further being configured to identify whether the control codes include predetermined control codes that can result in display artifacts;
output window logic configured to read output image data from the memory;
line counter logic configured to count lines of input image data received from the host CPU since receipt of the predetermined control codes, each line of input image data corresponding to a line of pixels of the input image;
smart blanker logic in electronic communication with the output window logic and the line counter logic, the smart blanker logic being configured to receive image data from the output window logic and generate modified image data, the modified image data containing the output image data in a region of the output display image that will not contain the display artifacts and data for blank pixels in a region of the output display image that can contain the display artifacts; and
a display interface configured to receive the modified image data and output the modified image data to a display device.

2. The graphics controller of claim 1, wherein the data for blank pixels comprise data for black pixels.

3. The graphics controller of claim 1, wherein the input window logic, the output window logic, and a display pipe are operable to implement the control codes, wherein the control codes include codes for specifying a mapping of the input image data to an output display screen, the mapping including implementing windowing and resizing of the input image data to the display screen.

4. The graphics controller of claim 1, wherein the input window logic, the output window logic, and a display pipe are operable to implement the control codes, wherein the control codes include codes for activating a data decompression algorithm for decompressing the input image data.

5. The graphics controller of claim 1, wherein the smart blanker modifies the image data corresponding to the display region that can contain the display artifacts until the number of lines counted by the line counter equals a number of lines of image data of the input window.

6. The graphics controller of claim 1, wherein the smart blanker modifies the image data corresponding to a portion the display region that can contain the display artifacts, the portion being areas of the display net yet written to by the host CPU as determined by the line counter.

7. An electronic device, having a smart blanking feature to prevent display artifacts, the electronic device comprising:
a host central processing unit (CPU);
a display device having a display screen, the display device being configured to display an output image on the display screen; and
a graphics controller, the graphics controller comprising:
input window logic in electronic communication with the host CPU for receiving input image data from the host CPU, the input image data comprising a plurality of intensity values for a plurality of pixels of an input image, the input window logic being configured to write the input image data to a memory in accordance with control codes received from the host CPU, the input window logic further being configured to identify whether the control codes include predetermined control codes that can result in display artifacts;
output window logic for reading output image data from the memory;
line counter logic for counting lines of input image data received from the host CPU since receipt of the predetermined control codes, each line of input image data corresponding to a line of pixels of the input image;
smart blanker logic in electronic communication with the output window logic and the line counter logic, the smart blanker logic being configured to receive image data from the output window logic and generate modified image data, the modified image data containing data for blank pixels in a region of the display that can contain the display artifacts; and
a display interface in communication with the display device, the display interface being configured for receiving the modified image data and outputting the modified image data to the display device.

8. The electronic device of claim 7, wherein the data for blank pixels comprise data for black pixels.

9. The electronic device of claim 7, wherein the input window logic, the output window logic, and a display pipe are operable to implement the control codes, wherein the control codes include codes for specifying a mapping of the input image data to an output display screen, the mapping including implementing windowing and resizing of the input image data to the display screen.

10. The electronic device of claim 7, wherein the input window logic, the output window logic, and a display pipe are operable to implement the control codes, wherein the control codes include codes for activating a data decompression algorithm for decompressing the input image data.

11. The electronic device of claim 7, wherein the smart blanker modifies the image data corresponding to the display region that can contain the display artifacts until the number of lines counted by the line counter equals a number of lines of image data of the input window.

12. The electronic device of claim 7, wherein the smart blanker modifies the image data corresponding to a portion the display region that can contain the display artifacts, the portion being areas of the display net yet written to by the host CPU as determined by the line counter.

13. A method for preventing display artifacts from occurring in an output display image, the method comprising:
receiving input image data from a host central processing unit (CPU), the input image data comprising a plurality of intensity values for a plurality of pixels of an input image;
writing the input image data to a memory in accordance with control codes received from the host CPU;
identifying whether the control codes received from the host CPU can result in display artifacts;
reading output image data from the memory;
when the control codes received from the host CPU can result in display artifacts, counting lines of input image data received from the host CPU since receipt of the control codes, each line of input image data corresponding to a line of pixels of the input image, and modifying image data received from the output window logic using a smart blanker, the smart blanker to generate modified image data, the modified image data containing the output image data in a region of the output display image that will not contain the display artifacts and data for blank pixels in a region of the output display image that can contain the display artifacts.

14. The method of claim 13, wherein the data for blank pixels comprise data for black pixels.

15. The method of claim 13, wherein the control codes include codes for specifying a mapping of the input image data to an output display screen, the mapping including implementing windowing and resizing of the input image data to the display screen.

16. The method of claim 13, wherein the control codes include codes for activating a data decompression algorithm for decompressing the input image data.

17. The method of claim 13, wherein the smart blanker modifies the image data corresponding to the display region that can contain the display artifacts until the number of lines counted by the line counter equals a number of lines of image data of the input window.

18. The method of claim 13, wherein the smart blanker modifies the image data corresponding to a portion the display region that can contain the display artifacts, the portion being areas of the display net yet written to by the host CPU as determined by the line counter.
